(19) United States
(12) Patent Application Publication
(10) Pub. No.: US 2004/0039802 A1
(43) Pub. Date: Feb. 26, 2004

(54) Obtaining pieces of operating code for a network device from multiple sources

(76) Inventor: Gary Glen Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/227,330

(22) Filed: Aug. 23, 2002

(51) Int. Cl. G06F 15/177

(52) U.S. Cl. 709/222

(57) ABSTRACT

Obtaining pieces of operating code for a network device from multiple sources are described herein. In accordance with one aspect, the pieces of the operating code are obtained from different sources and are used to control the network device. In accordance with another aspect, a request to modify an identifier of the pieces of the operating code is received, and the identifier is modified in accordance with the request.

### TECHNICAL FIELD

This invention relates generally to network devices, and more particularly to obtaining pieces of operating code for a network device from multiple sources.

### BACKGROUND

Nearly every network device requires basic operating code to accomplish its intended functionalities. Network printers, for example, normally include a rudimentary operating system (OS) that controls all printer functions including translating data received from other devices, rasterizing data, operating the print engine, etc. Normally, the basic operating code is stored in read only memory (ROM) or on a hard disk of the network device and portions of the code are brought into random access memory (RAM) when those portions are to be executed.

Although such arrangements function adequately well, they do have some problems. For one, where the operating code is stored in ROM, the cost of the device is increased due to the cost of including the ROM elements. Another problem is that when the operating code is stored locally in the device, updating of the code requires manual downloading of new versions of code for each network device separately. Where many such network devices are used on a particular network, for instance in an office local area network (LAN), this manual downloading of each device can be tedious and inefficient.

Obtaining pieces of operating code for a network device from multiple sources as described herein helps solve these problems.

### SUMMARY

Obtaining pieces of operating code for a network device from multiple sources are described herein.

In accordance with certain embodiments, an operating code identifier that identifies a plurality of operating code sources is accessed by a network device. Each of the plurality of operating code sources is also accessed, and a different piece of the operating code is obtained from each of the plurality of operating code sources. The pieces of the operating code are used to control the network device.

In accordance with other embodiments, a request is received for a piece of operating code for a network device, wherein the requested piece of operating code is one of a plurality of pieces used by the network device to boot. The requested piece of operating code is obtained and returned to the requestor.

In accordance with certain other embodiments, an indication to obtain operating code for a printer is received at a computing device from a printer coupled to the computing device. A plurality of pieces of the operating code for the printer are identified, obtained from a plurality of sources, and communicated to the printer for use by the printer in booting.

In accordance with additional embodiments, a request to modify an identifier in a network device is received, wherein the identifier identifies a plurality of portions of operating code used to boot the network device. The identifier is modified in accordance with the request.

### BRIEF DESCRIPTION OF THE DRAWINGS

FIG. 1 illustrates an exemplary environment in which network devices can be employed.

FIG. 2 is a block diagram illustrating an exemplary printer in additional detail.

FIG. 3 illustrates an exemplary operating code identifier.

FIG. 4 is a block diagram illustrating another exemplary printer in additional detail.

FIG. 5 is a flowchart illustrating an exemplary process for booting a network device by obtaining pieces of its operating code from different sources.

FIG. 6 is a flowchart illustrating an exemplary process for loading pieces of operating code from different sources.

FIG. 7 is a flowchart illustrating an exemplary process for providing a piece of operating code for a network device.

FIG. 8 is a flowchart illustrating an exemplary process for modifying an operating code identifier.

FIG. 9 illustrates portions of an exemplary device in additional detail.

### DETAILED DESCRIPTION

Obtaining pieces of operating code for a network device from multiple sources is described herein. The operating code for a network device, which controls the operation of the device (including booting the device), is made up of multiple pieces. As part of the booting process, the network device obtains and stores the pieces from multiple sources, allowing the network device to perform its intended functionality. One or more of these operating code pieces may be changed (e.g., by the device manufacturer or a system administrator) and new pieces reflecting the changes readily incorporated into the booting process, as discussed in more detail below.

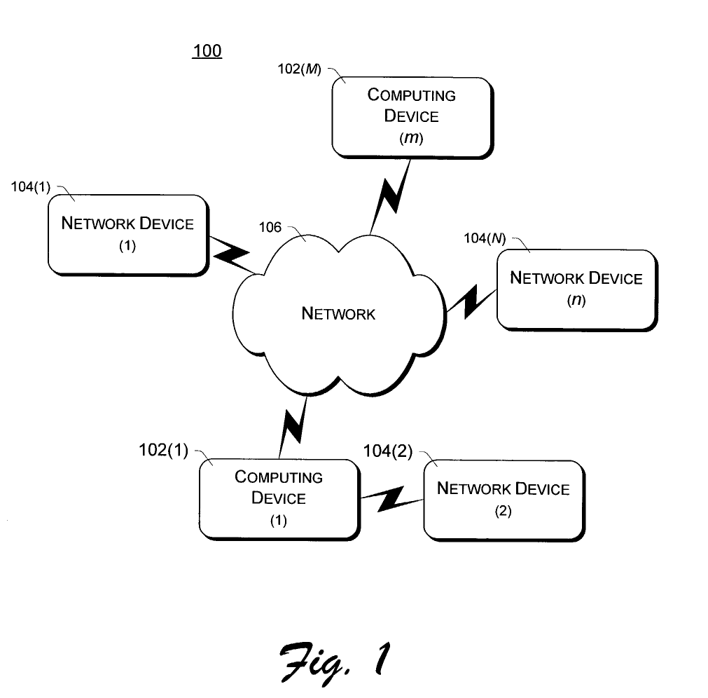

FIG. 1 illustrates an exemplary environment 100 in which network devices can be employed. In environment 100, multiple (m) computing devices 102 are coupled to one or more of multiple (n) network devices 104 via a network 106 and/or directly. Network 106 is intended to represent any of a variety of conventional network topologies, types, and technologies (e.g., one or more of optical, wired, wireless, etc.), employing any of a variety of conventional network protocols (including public and/or proprietary protocols). In one exemplary implementation, network 106 includes the Internet.

Computing devices 102 can be any of a variety of conventional computing devices, including desktop PCs, workstations, server computers, Internet appliances, gaming consoles, handheld PCs, cellular telephones, personal digital assistants (PDAs), etc. Computing devices 102 can be the same types of devices, or alternatively different types of devices. Computing devices 102 may communicate commands to a network device(s) 104 and/or may store pieces of operating code for a network device(s) 104, as discussed in more detail below.

Network devices 104 can be any of a variety of dedicated network devices, also referred to herein as embedded systems. A network device 104 differs from a computing device in that a network device is a dedicated network device designed to perform particular functions, rather than being a general-purpose computing system designed to be programmable to perform virtually any function(s). Examples of such network devices include printers, scanners, copiers, facsimile machines, network radios (e.g., Internet radios), Internet appliances, game consoles, weather stations, and so forth. Although many of the discussions herein reference printers, such references are exemplary only and the discussions regarding the operating code for such printers apply analogously to other network devices.

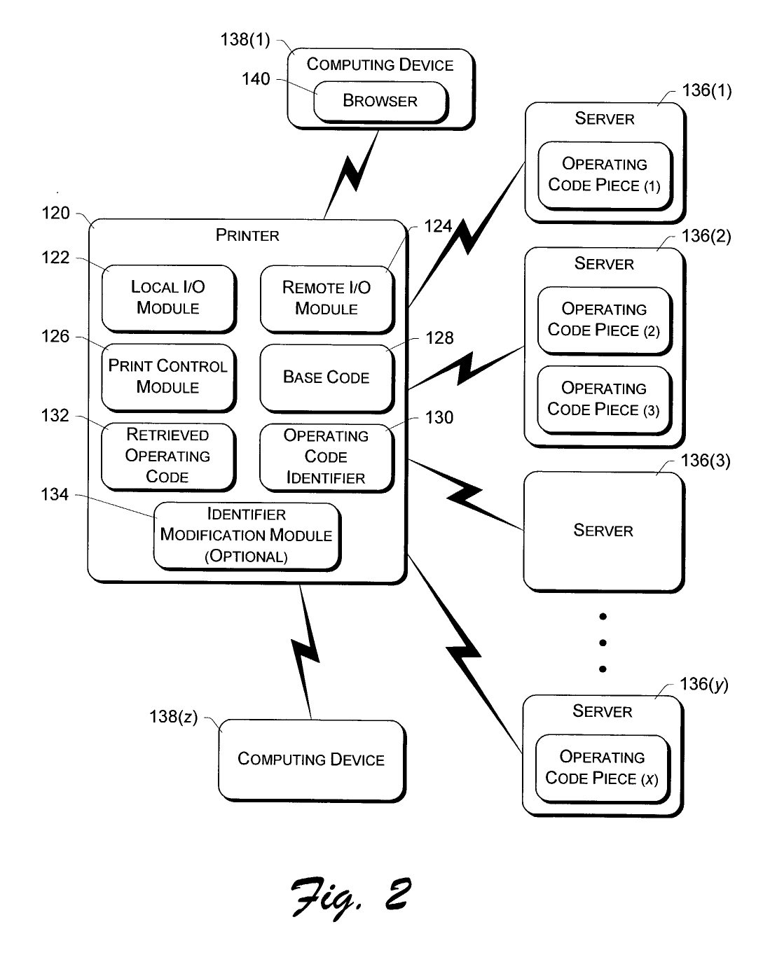

FIG. 2 is a block diagram illustrating an exemplary printer 120 in additional detail. Printer 120 can be, for example, a network device 104 of FIG. 1. Printer 120 can be any of a variety of imaging devices capable of generating a hard copy of data (e.g., received from one of computing devices 102 of FIG. 1). Printer 120 can generate hard copies of data in any of a variety of manners, such as by using toner (e.g., in laser printers), ink (e.g., in inkjet printers, bubblejet printers, dot matrix printers, etc.), heat applied to heat-sensitive print media (e.g., thermal printers), and so forth. Printer 120 may also incorporate additional functionality, for example, such as the ability to scan hard copies of documents and generate digital representations of such documents, send and/or receive data as a facsimile machine, and so forth.

Printer 120 includes several modules or components: a local I/O module 122, a remote I/O module 124, a print control module 126, a base code module 128, an operating code identifier 130, retrieved operating code 132, and optionally an identifier modification module 134. The modules and components in FIG. 2 are exemplary only; the exact components included in any particular computing device can vary based on the type of device.

Local I/O module 122 controls the local input of commands and/or data to printer 120. In one implementation, printer 120 includes a display (e.g., LED screen, LCD screen, etc.) via which prompts and information can be displayed to a local user of printer 120 (e.g., a user standing at printer 120 rather than accessing printer 120 via a network), and an input mechanism (e.g., touchscreen, keypad, etc.) via which the local user can input commands and/or data to printer 120. Retrieved operating code 132 (after the various pieces are retrieved) includes instructions that, when executed, manage the displaying of such information or prompts, as well as the receipt of input commands and/or data and the routing of such inputs to the appropriate components of printer 120.

Remote I/O module 124 manages communication between printer 120 and one or more remote devices (e.g., via network 106 of FIG. 1). In one implementation, remote I/O module 124 includes circuitry to transmit and receive signals via a wired and/or wireless network connection. Base code 128 includes sufficient instructions to allow printer 120 to communicate, via remote I/O module 124, with remote devices in order to obtain the operating code for printer 120, as discussed in more detail below. Retrieved operating code 132 (after the various pieces are retrieved) includes instructions that, when executed, manage communications with various computing devices and servers via remote I/O module 124.

Print control module 126 manages the printing of data by printer 120 in a conventional manner in order to generate a hard copy of the data. This management is implemented, at least in part, by execution of retrieved operating code 132 (after the various pieces are retrieved). Print requests can be received via a network (e.g., network 106 of FIG. 1) and/or directly from a computing device. One or more computing devices can submit print requests to printer 120.

When printer 120 is powered-on or reset, printer 120 goes through a boot process to establish its operating code in its memory (e.g., RAM) in order to be able to perform its intended function(s). When desired, a user and/or system administrator can reset printer 120 in different manners, such as by pressing a reset button on printer 120, by sending a reset command to printer 120 via local I/O module 122 or remote I/O module 124 (e.g., a “reset” option on a web page being served from printer 120), etc. Base code 128 includes sufficient instructions to allow printer 120 to access multiple operating code sources in order to obtain the various pieces of the operating code and store it as retrieved operating code 132. Once retrieved, the various pieces collectively are executed to boot printer 120 and provide the intended functionality of printer 120.

As used herein, the term “operating code” refers generally to the operating system (OS) that controls the functionality of printer 120, including translation of data, rasterizing, operation of the print engine, and so forth.

Also, as used herein, the term “base code” excludes the normal operating code upon which printer 120 relies to carry out its normal operation (e.g., printing). This base code is normally stored in some non-volatile memory such as ROM or an internal hard disk, depending upon the particular configuration of printer 120. Although other code can, optionally, be stored in the non-volatile memory as well, such code may not be stored locally so as to both reduce the amount of storage space that is required (and thereby reduce the cost of the device), and to permit simplified updating of the device operating code. Alternatively, however, the non-volatile memory could include a default operating code or default pieces of operating code to use as a backup in the event communication cannot be established with a source of a particular piece of the operating code.

The operating code sources can include one or more of server devices 136(1), 136(2), 136(3), . . . , 136(y), and/or one or more local devices (e.g., a hard drive (not shown in FIG. 2) that is part of printer 120). Each server device 136 may store zero or more pieces of the operating code for printer 120. Server devices 136 may be coupled to printer 120 via one or more networks. For example, one server device 136 may be accessible to printer 120 via the office LAN that printer 120 is part of, while another server device 136 may be accessible via the Internet.

Operating code identifier 130 is an indication of the sources for each of the multiple pieces or portions of the operating code to be retrieved. In one exemplary implementation, operating code identifier 130 is a list of multiple Uniform Resource Locators (URLs), each of which identifies a file to be retrieved as a piece of the operating code as well as the location of that file (e.g., a particular folder or directory of a server 136). Alternatively, each item in the list may identify a server and rely on the server to submit the proper file for the printer when requested (e.g., an indication of a type of piece, such as a piece to support an additional input tray, may be included in the request to retrieve the piece from the server device).

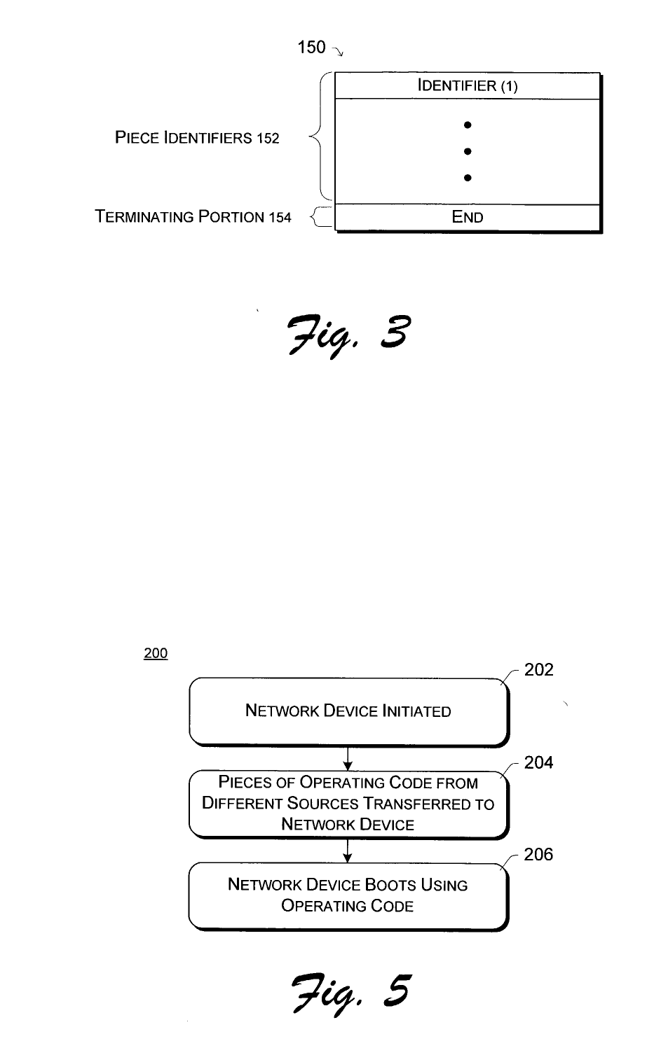

FIG. 3 illustrates an exemplary operating code identifier 150, which may be operating code identifier 130 of FIG. 2. Operating code identifier 150 includes a first portion 152 which includes identifiers of one or more pieces of the operating code, and a second portion 154 which terminates the identifier 150 (that is, identifies the end of the code piece identifiers). Terminating portion may be implemented in any of a variety of manners, such as an end of file indication, a line with no data other than an end of line indication, some other predetermined symbol, and so forth.

Returning to FIG. 2, operating code identifier 130 can identify the operating code pieces directly or indirectly. In other words, the specific location of the operating code pieces may be included in identifier 130 (directly identifying the operating code pieces), or another location may be included in identifier 130, this other location indicating the specific location of the operating code pieces (indirectly identifying the operating code pieces). Operating code identifier 130 may also identify some operating code pieces directly and other operating code pieces indirectly.

Identifying one or more pieces of the operating code indirectly allows the supplier of that piece of the operating code to change the operating code as desired without requiring any change to operating code identifier 130 in printer 120. For example, operating code identifier 130 may identify, for a piece of code, a particular file name (e.g., “corelatest.exe”) and server where the file is located. The supplier of that piece of code simply keeps its most recent version of the piece in “corelatest.exe” at that server.

In one exemplary implementation, operating code identifier 130 is a list of pieces that have been verified by another party (e.g., the manufacturer of printer 120 or alternatively some other party) as functioning together properly. This listing is also referred to herein as a “recipe”. When new versions of a piece of the operating code are available, they can be tested (by this other party) for compatibility with the other pieces of the operating code. Once they have been verified as operating together properly, they can be listed in a recipe. The new recipe can then be added to printer 120 (if identifier 130 identifies the recipe directly) or added to the location where printer 120 looks for the recipe (if identifier 130 identifies the recipe indirectly). By using a recipe, a system administrator or other user of printer 120 can be assured that the versions of the pieces included in the operating code have been verified as functioning together properly.

In certain embodiments, operating code identifier 130 can be modified by a user, such as a system administrator. A user may desire to modify identifier 130 for a variety of different reasons, such as to identify a new version of a piece of the operating code, to add a new recipe, to add functionality to printer 120, to remove functionality from printer 120, and so forth. For example, printer 120 may be manufactured with a default identifier 130 that the subsequent purchaser desires to change, new versions of pieces of the operating code may become available, or new hardware (e.g., an additional paper tray) may be added. An identifier modification module 134 is included to allow a user(s) to make modifications to operating code identifier 130. Module 134 may be accessed by a user via local I/O module 122 and/or remote I/O module 124.

Module 134 can support modifications to operating code identifier 130 in a variety of manners. In one exemplary implementation, commands can be issued by a remote device, such as one of computing devices 138, indicating what modifications are to be made to identifier 130. For example, a command similar to a print request (but without any data to be printed) may be sent from a computing device 138 to indicate to module 134 what modifications are to be made to operating code identifier 130. By way of another example, a command to modify identifier 130 may be entered via a touchscreen or keypad interface of local I/O module 122 and routed to module 134. Different commands may also be supported by module 134 to allow the current identifier 130 to be displayed to the user (e.g., via local I/O module 122 or the user's computing device 138), thereby allowing the user to see the current identifier before having any modifications made to the identifier.

In one exemplary implementation, identifier modification module 134 operates as a conventional web server (e.g., conforming to the HTTP (HyperText Transfer Protocol) protocol). A conventional web browser 140 of a client device 138 is able to access the web server (module 134) and load content (e.g., web pages, JavaScripts, Java applets, Virtual Basic Scripts (VBScripts), etc.) from the web server. A conventional communication channel or connection can be established between web browser 140 and the web server via which such content can be transferred. In addition, information entered by a user to web browser 140 (e.g., data entry into fields of a web page, responses to queries from a JavaScript, etc.) can also be returned to the web server via this communication channel or connection.

Web server 136, when accessed by web browser 140, communicates the current operating code identifier 130 to web browser 140. Identifier modification options are also communicated to web browser 140, allowing a user of web browser 140 to add, remove, rename, reorder, etc. the identifiers of the individual pieces of the operating code. In one exemplary implementation, these options are presented to a user of web browser 140 as a web page (e.g., written in HTML (HyperText Markup Language)). The user is able to select from the various options presented to him or her, modifying the operating code identifier 130 as he or she desires. When the user is finished entering the desired modifications (e.g., as indicated by user selection of a “done” or “quit” button or other selectable option), web browser 140 returns the user selections to the web server, which in turn modifies the operating code identifier 130 in accordance with the returned selections.

Identifier modification module 134 can be informed of changes to be made to operating code identifier 130 as a set of one or more differences (e.g., an indication of a file name that is to be changed, an indication of a file name that is to be deleted, an indication of a location and file name that is to be added, etc.). Module 134, upon receipt of this set of one or more differences, makes the appropriate modifications to operating code identifier 130. Alternatively, identifier modification module 134 may receive a replacement operating code identifier, in response to which module 134 replaces the previous operating code identifier with the new operating code identifier.

Once the changes have been communicated to module 134 and operating code identifier 130 modified in accordance with the changes, printer 120 can be reset. Resetting printer 120 causes printer 120 to re-boot and thus obtain new operating code based on the modified operating code identifier. In one exemplary implementation, when a reset is requested printer 120 delays resetting itself until identifier modification module 134 has finished updating operating code identifier 130. This delay prevents, for example, printer 120 being reset while module 134 is writing the new operating code identifier to memory. The delay may be a fixed value (e.g., a delay of a few seconds), or alternatively a variable value (e.g., delay until confirmation is received from identifier modification module 134 that the new operating code identifier has been written to memory).

Operating code identifier 130 may be a list of one or more location and/or file identifiers, as discussed above, or may alternatively be a set of rules or instructions that are analyzed or executed to determine the proper pieces of operating code to retrieve. These rules or instructions can set one or more conditions and, based on whether those condition(s) are satisfied, indicate which pieces of operating code are to be retrieved for printer 120. Different conditions can be established, such as the type of printer, what type of attachments have been added to the printer (e.g., an output sorter, a large input tray, a stapler, a scanning device, etc.), whether the user of the printer has paid certain fees or whether a user's subscription fee to particular functionality or services (and to the pieces of code to implement that functionality or services) has been paid, whether other pieces have already been retrieved or are to be subsequently retrieved, whether the printer has permission to load particular signature fonts (particular digital signatures), which language to load (e.g., based on a setting in nonvolatile memory, which language the user interface portions of the operating code should be in, such as English, French, Spanish, German, Japanese, Chinese, etc.), and so forth. The manner in which these different conditions are checked can vary, depending on how the printer (and attachments, if any) is designed. For example, some information (such as the printer type) may be readily identified based on information stored in nonvolatile memory of printer 120. By way of another example, some information (such as what attachments are coupled to the printer) can be readily identified by issuing a query over an appropriate communications channel (e.g., a bus) on which other components (e.g., the attachments) are listening and will respond to the query.

Such rules and/or instructions can be processed in a variety of manners. In one exemplary implementation, the rules are a list of conditions and corresponding results (e.g., if the printer is a Hewlett Packard LaserJet 8150, then load the piece “printers.hp.com/laserjet/8150/core21.exe”) which are accessed and processed by base code 128. For each condition that is satisfied, base code 128 retrieves the piece(s) indicated by the result. In another exemplary implementation, operating code identifier 130 is a script file or batch file that is executed, under control of base code 128. The script or batch file has the corresponding conditions and results that are applied when the file is executed, and the resultant pieces of the operating code are retrieved.

Implementing such a set of rules or instructions allows a system administrator to use the same operating code identifier for each printer he or she is responsible for managing, even though the printers may be different models, have different functionality and/or attachments, etc. For example, a network administrator responsible for managing fifty printers can establish the rules and/or instructions once, and then install the same operating code identifier on all fifty printers. Any subsequent modifications (e.g., to support a new version of a piece of the operating code) can similarly be made once and then the same modified rules and/or instructions installed on all fifty printers.

Operating code identifier 130 may also optionally identify multiple sources for the same piece of the operating code. An attempt is made to retrieve the piece from one of the sources (e.g., the first-listed source, a primary source, etc.). If the attempt is successful then the other sources need not be accessed. However, if the attempt is not successful, then one or more of the other sources (e.g., a secondary source) is accessed in an attempt to obtain the piece of code from the other source(s). Identifying such multiple sources allows the appropriate pieces of the operating code to be loaded even though one or more sources of the pieces may not be available (e.g., due to the server device storing the piece malfunctioning, a malfunction in a network connection, etc.).

In another exemplary implementation, rather than storing operating code identifier 130 in nonvolatile memory, printer 120 accesses a server device 136 to obtain the operating code identifier 130. For example, when printer 120 is powered-on or reset, base code 128 attempts to obtain a network address from a server device 136 responsible for assigning network addresses. When requesting a network address, printer 120 typically provides some information to identify itself (e.g., the MAC address of printer 120). The server device maintains (and/or has access to) a mapping of printer identifiers to operating code identifiers and determines the appropriate operating code identifier for the printer. Alternatively, the server device may send a request to another device (e.g., a server maintained by the manufacturer of printer 120) for the other device to determine the appropriate operating code identifier for the printer. Once obtained, the server device returns the appropriate operating code identifier to printer 120.

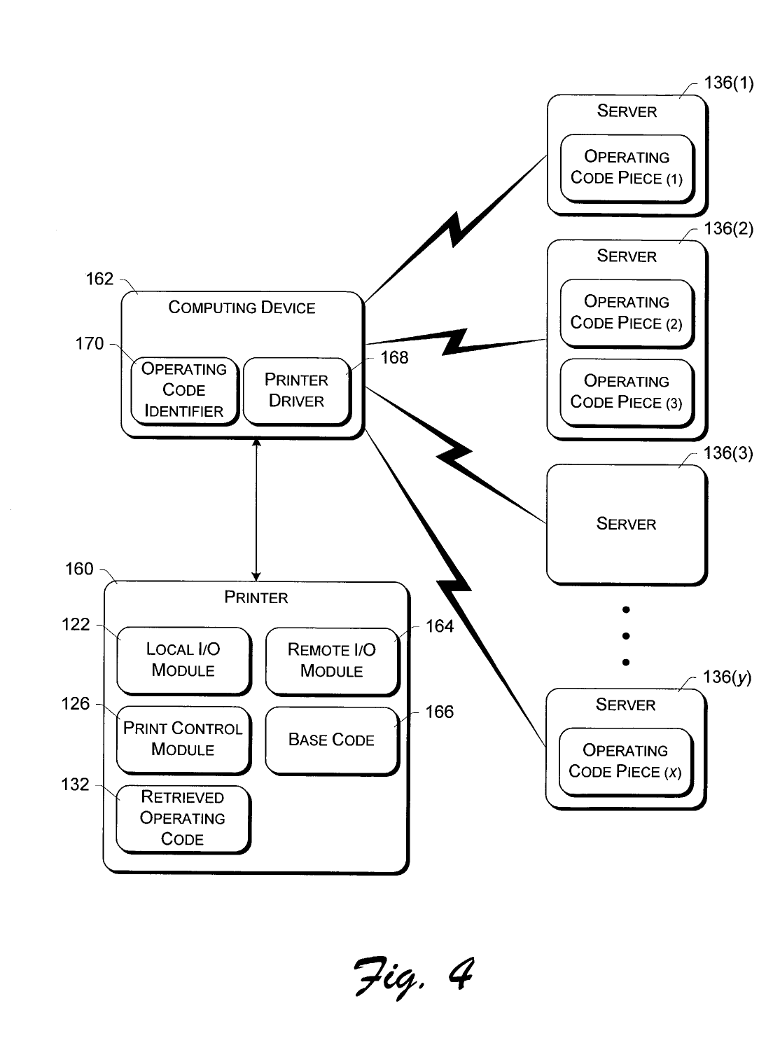

FIG. 4 is a block diagram illustrating an exemplary printer 160 in additional detail. Printer 160 can be, for example, a network device 104 of FIG. 1. Analogous to printer 120 of FIG. 2, printer 160 can be any of a variety of imaging devices capable of generating a hard copy of data in any of a variety of manners, and may optionally incorporate additional functionality. Printer 160 also includes a local I/O module 122, a print control module 126, and retrieved operating code 132, analogous to printer 120.

Printer 160, however, differs from printer 120 of FIG. 2 in that printer 160 is coupled to server devices 136 via a computing device 162. Printer 160 includes a remote I/O module 164 that allows printer 160 to communicate with computing device 162. Remote I/O module 164 may include, for example, circuitry to transmit and receive signals via a wired and/or wireless connection, such as USB (Universal Serial Bus), parallel port, serial port, firewire (IEEE 1394), Infrared (IR), IEEE 802.11, etc. Base code 166 includes sufficient instructions to allow printer 160 to communicate, via remote I/O module 164, with computing device 162 in order to obtain the operating code for printer 160.

When printer 160 is powered-on or reset, base code 166 communicates an indication to a printer driver 168 (of computing device 162) that printer 160 requests its operating code. This indication may be a particular request or message, or alternatively may be inherent in printer 160 being powered-on or reset (e.g., computing device 162 recognizing that printer 160 is coupled to device 162 and is powered on serves as the indication). Printer driver 168 obtains the pieces of the operating code for printer 160, based on operating code identifier 170, and returns the obtained pieces to printer 160. Printer 160, in turn, stores the pieces received from printer driver 168 as retrieved operating code 132.

Printer driver 168 obtains the pieces of the operating code in a manner(s) analogous to the discussions above regarding printer 120 of FIG. 2. Printer driver 168 may also optionally allow operating code identifier 170 to be modified, analogous to the discussions above regarding printer 120 of FIG. 2. Any information that printer driver 168 may need about printer 160 in order to determine the appropriate pieces of operating code to obtain may be obtained by driver 168 by querying printer 160 via remote I/O module 164, or alternatively may be provided to driver 168 by base code 166 along with the indication that printer 160 requests its operating code.

In FIG. 4, printer 160 need not maintain its operating code identifier nor any functionality to allow the operating code identifier to be modified. Rather, the operating code identifier and any functionality to allow the operating code identifier to be modified are maintained by computing device 162.

Although only a single computing device 162 and printer 160 are illustrated in FIG. 4, it is to be appreciated that a single computing device can obtain operating code for multiple printers analogous to printer 160. Computing device 162 can obtain the same operating code for all such printers, or alternatively obtain different operating code for different printers. Different operating code identifiers can be maintained by computing device 162 for the multiple printers, or alternatively the same operating code identifier can be maintained for the multiple printers (e.g., a batch or script file if there are different types of printers, or the same list of identifiers if the printers are all the same type).

FIG. 5 is a flowchart illustrating an exemplary process 200 for booting a network device by obtaining pieces of its operating code from different sources. Initially, the network device is initiated (act 202). This initiation may be, for example, powering-on the device or resetting the device. The pieces of the operating code are then obtained from different sources and transferred to the network device (act 204). These different pieces may be obtained by the network device itself, or alternatively by another device(s) on behalf of the network device. Once obtained, the network device boots using the obtained operating code (act 206).

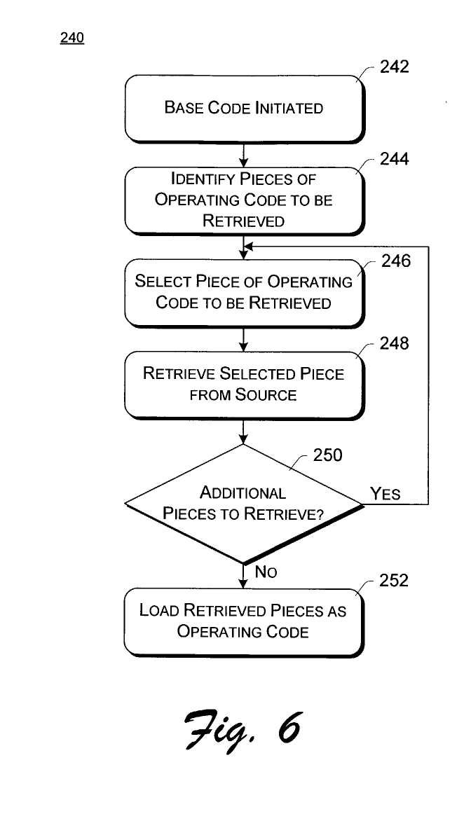

FIG. 6 is a flowchart illustrating an exemplary process 240 for loading pieces of operating code from different sources. Process 240 may be implemented within the network device for which the operating code is being obtained, or alternatively portions of process 240 may be implemented by another device(s) on behalf of the network device.

Initially, the base code of the network device is initiated (act 242), such as by the device being powered-on or reset. The pieces of the operating code to be retrieved are identified (act 244) and a piece is selected (act 246). The source of the selected piece is then accessed and the selected piece retrieved from the source (act 248). Process 240 then continues based on whether there are additional pieces of the operating code to be retrieved (act 250). If there are additional pieces to be retrieved, then another such piece is selected (act 246). However, if there are no additional pieces to retrieve, then the retrieved pieces are loaded as the operating code for the device (act 252).

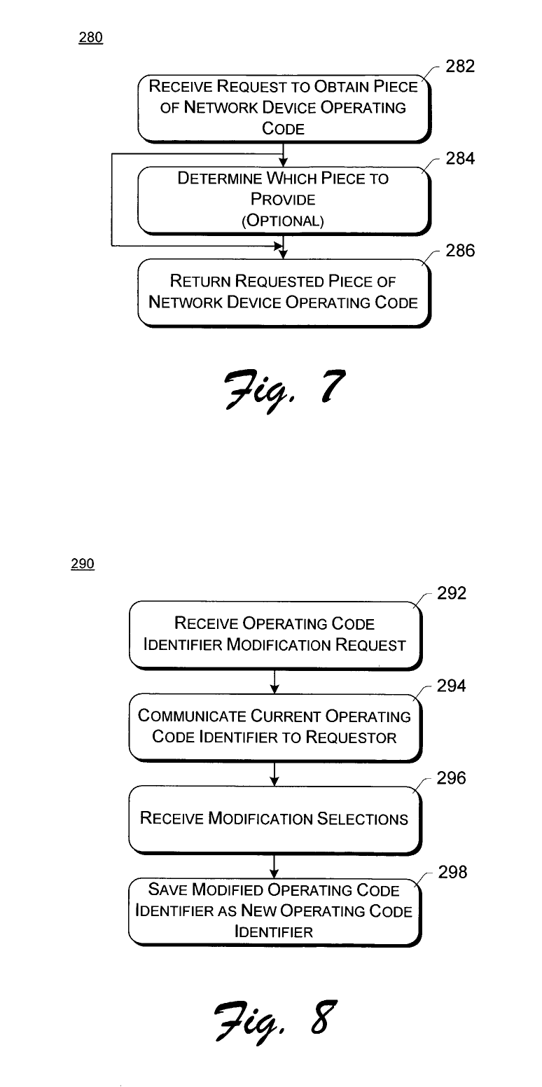

FIG. 7 is a flowchart illustrating an exemplary process 280 for providing a piece of operating code for a network device. Process 280 may be implemented within the network device for which the operating code is being obtained (e.g., the piece being stored on a local hard drive), or alternatively on a server device.

Initially, a request to obtain a piece of the operating code is received (act 282). The requester may be, for example, the network device for which the operating code is being obtained, or alternatively another device acting on behalf of the network device. Depending on the request, the specific piece being requested may be identified (e.g., by file name and location) or alternatively may not be identified. If the specific piece is not identified, then a determination is made as to which piece the receiver should provide (act 284). This determination can be made, for example, based on a location identified by the request or a printer type or piece description identified by the request. Once identified, the requested piece of the operating code is returned to the requestor (act 286).

Alternatively, in certain embodiments, process 280 may include verification of the requestor in order to ensure that the requestor is authorized to download the piece of the operating code. This verification can be performed in a variety of different manners, such as based on an identifier of the requester, a requestor id/password combination, a certificate or other digitally signed statement from the requester, and so forth.

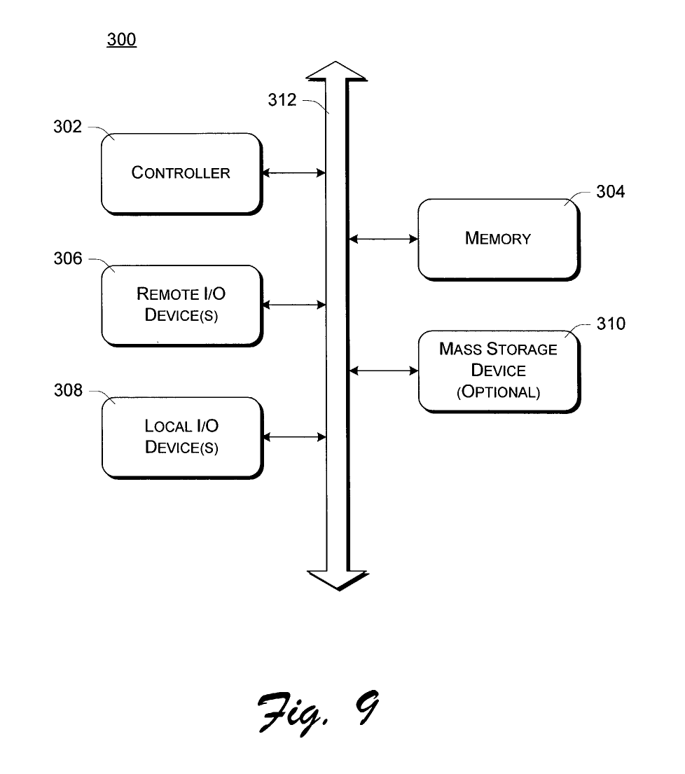

FIG. 8 is a flowchart illustrating an exemplary process 290 for modifying an operating code identifier. Process 290 may be implemented within the network device for which the operating code is being obtained (e.g., the piece being stored on a local hard drive), or alternatively on a server device.

Initially, an operating code identifier modification request is received (act 292). As discussed above, this request can be received from a remote device or alternatively locally. The current operating code identifier is communicated to the requestor (act 294), allowing the person desiring to change the identifier to see the current identifier. Modification selections are then received from the requestor (act 296), and the modified operating code identifier is saved as the new operating code identifier (act 298).

Alternatively, in certain embodiments, process 290 may include verification of the requestor in order to ensure that the requestor is authorized to download the piece of the operating code. This verification can be performed in a variety of different manners, such as based on an identifier of the requester, a requestor id/password combination, a certificate or other digitally signed statement from the requester, and so forth.

FIG. 9 illustrates portions of an exemplary device 300 in additional detail. Device 300 can be, for example: a computing device 102 or network device 104 of FIG. 1; a printer 120, computing device 138, or server device 136 of FIG. 2; or a printer 160, computing device 162, or server device 136 of FIG. 4. Device 300 includes a processor or controller 302, a memory 304, a remote I/O device(s) 306, a local I/O device(s) 308, and an optional mass storage device 310, all coupled to a bus 312. Depending on the type of the device, various additional conventional components may also be typically included in device 300 (e.g., a printer will typically include a print engine, print media inputs and outputs, etc.).

Controller or processor 302 can be a general purpose microprocessor or a dedicated microcontroller (e.g., one or more Application Specific Integrated Circuits (ASICs) or programmable logic devices (PLDs)). Remote I/O device(s) 306 is one or more conventional interface devices allowing components of device 300 (e.g., controller 302) to communicate with other devices external to device 300. Remote I/O device(s) 306 may include, for example, a modem, a network interface card (NIC), a parallel port, a serial port, a universal serial bus (USB) port, and so forth. Local I/O device(s) 308 is an interface device allowing local commands and/or data to be input to and/or output from device 300. Local I/O device(s) 308 may include, for example, a display device (e.g., liquid crystal display (LCD), light emitting diode (LED), etc.), a keypad (e.g., alphanumeric or otherwise), a touchscreen, a cursor control device (e.g., a trackpad, trackball, etc.), print media handlers and printing components (e.g., ink or toner dispensers), and so forth.

Bus 312 represents one or more buses in device 300, which may be implemented in accordance with public and/or proprietary protocols. The bus architecture can vary by device as well as by manufacturer. Mass storage device 310 is optional and represents any of a variety of conventional storage devices, such as fixed or removable magnetic or optical disks, Flash memory, etc.

Memory 304 represents volatile and/or nonvolatile memory used to store instructions and data for use by controller or processor 302. Typically, instructions are stored on a mass storage device 310 (or nonvolatile memory portion of memory 304) and loaded into a volatile memory portion of memory 304 for execution by controller or processor 302. Additional memory components may also be involved, such as cache memories internal or external to controller or processor 302. Various embodiments of the invention may be implemented, at different times, in any of a variety of computer readable media that is part of, or readable by, device 300. For example, such computer readable media may be mass storage device 310, memory 304, a cache memory, media (e.g., a magnetic or optical disk) accessible to device 300, and so forth.

Device 300 is exemplary only. It is to be appreciated that additional components (not shown) can be included in device 300 and some components illustrated in device 300 need not be included. For example, additional processors or storage devices, additional I/O interfaces, and so forth may be included in device 300, or mass storage device 310 may not be included.

Various discussions herein refer to components and modules that can be implemented in a printer or computing device. It is to be appreciated that the components and processes described herein can be implemented in software, firmware, hardware, or combinations thereof. By way of example, a programmable logic device (PLD) or application specific integrated circuit (ASIC) could be configured or designed to implement various components and/or processes discussed herein.

Although the description above uses language that is specific to structural features and/or methodological acts, it is to be understood that the invention defined in the appended claims is not limited to the specific features or acts described. Rather, the specific features and acts are disclosed as exemplary forms of implementing the present invention.

1. One or more computer readable media having stored thereon a plurality of instructions that, when executed by one or more controllers of a network device, causes the one or more controllers to:
access an operating code identifier that identifies a plurality of operating code sources;
access each of the plurality of operating code sources and obtain, from each of the plurality of operating code sources, a different piece of the operating code; and
use the different pieces of the operating code to control the network device.

2. One or more computer readable media as recited in claim 1, wherein the instructions further cause the one or more controllers to obtain the operating code in response to a reset command received from a computing device coupled to the network device.

3. One or more computer readable media as recited in claim 1, wherein the operating code identifier comprises a list of Uniform Resource Locators (URLs).

4. One or more computer readable media as recited in claim 1, wherein the operating code identifier comprises a recipe.

5. One or more computer readable media as recited in claim 1, wherein the operating code identifier identifies a remote location, and wherein the remote location includes a list of both the plurality of operating code sources and which pieces of the operating code are to be obtained from which sources.

6. One or more computer readable media as recited in claim 1, wherein the instructions further cause the one or more controllers to obtain, from another server device, the operating code identifier as well as a network address for the network device.

7. One or more computer readable media as recited in claim 1, wherein one or more of the plurality of operating code sources comprises a mass storage device of the network device.

8. One or more computer readable media as recited in claim 1, wherein one or more of the plurality of operating code sources comprises a remote server device.

9. One or more computer readable media as recited in claim 1, wherein one of the plurality of sources comprises a mass storage device of the network device, and one of the plurality of operating code sources comprises a remote server device.

10. One or more computer readable media as recited in claim 1, wherein the operating code identifier comprises a set of conditions and corresponding results.

11. One or more computer readable media as recited in claim 1, wherein the operating code identifier comprises a script file that is to be executed by the one or more controllers.

12. One or more computer readable media as recited in claim 1, wherein operating code identifier comprises a batch file that is to be executed by the one or more controllers, and wherein the batch file identifies, for a piece of the operating code, both a primary source and one or more secondary sources.

13. One or more computer readable media as recited in claim 1, wherein the operating code identifier comprises a set of instructions that are to be executed by the one or more controllers to determine a type of the network device and determine the pieces of the operating code based at least in part on the type.

14. One or more computer readable media as recited in claim 1, wherein the operating code identifier comprises a set of instructions that are to be executed by the one or more controllers to determine one or more attachments to the network device, and to determine the different pieces of the operating code based at least in part on the one or more attachments.

15. One or more computer readable media as recited in claim 1, wherein the network device comprises a printer.

16. A method comprising:
receiving, from a requestor, a request for a piece of operating code for a network device, wherein the requested piece of operating code is one of a plurality of pieces used by the network device to boot;
obtaining the requested piece of operating code; and
returning the requested piece of operating code to the requestor.

17. A method as recited in claim 16, wherein the requestor comprises the network device.

18. A method as recited in claim 16, wherein the network device comprises a printer.

19. A method as recited in claim 16, wherein the requestor comprises a computing device coupled to the network device.

20. A method as recited in claim 16, wherein the other pieces of the plurality of pieces are to be obtained by the requestor from other sources.

21. A method as recited in claim 16, wherein the receiving comprises receiving the request via the Internet.

22. One or more computer readable media having stored thereon a plurality of instructions that, when executed by one or more processors of a computing device, causes the one or more processors to:
receive, from a printer coupled to the computing device, an indication to obtain operating code for the printer;
identify a plurality of pieces of the operating code for the printer;
obtain, from a plurality of sources, the plurality of pieces; and
communicate the plurality of pieces to the printer for use by the printer in booting.

23. One or more computer readable media as recited in claim 22, wherein the instructions that cause the one or more processors to identify the plurality of pieces of the operating code for the printer further comprise instructions that cause the one or more processors to retrieve, from a remote location, an identification of the plurality of pieces.

24. One or more computer readable media as recited in claim 22, wherein the instructions that cause the one or more processors to identify the plurality of pieces of the operating code for the printer further comprise instructions that cause the one or more processors to process a set of conditions and corresponding results to identify the plurality of pieces.

25. One or more computer readable media as recited in claim 22, wherein the instructions that cause the one or more processors to identify the plurality of pieces of the operating code for the printer further comprise instructions that cause the one or more processors to execute a batch file that identifies, for a piece of the operating code, both a primary source and one or more secondary sources.

26. One or more computer readable media as recited in claim 22, wherein the instructions that cause the one or more processors to identify the plurality of pieces of the operating code for the printer further comprise instructions that cause the one or more processors to execute a set of instructions to determine a type of the printer and determine the pieces of the operating code based at least in part on the type.

27. One or more computer readable media as recited in claim 22, wherein the instructions that cause the one or more processors to identify the plurality of pieces of the operating code for the printer further comprise instructions that cause the one or more processors to execute a set of instructions to determine one or more attachments to the printer, and to determine the pieces of the operating code based at least in part on the one or more attachments.

28. One or more computer readable media having stored thereon a data structure, the data structure comprising:
a plurality of portions, each portion including data identifying a different piece of a plurality of pieces of operating code to be used collectively to control a printer; and
a terminating portion including data identifying an end to the portions in the plurality of portions.

29. One or more computer readable media as recited in claim 28, wherein at least one of the plurality of portions includes a condition and corresponding result.

30. One or more computer readable media as recited in claim 28, wherein the plurality of pieces of operating code to be used collectively to control the printer comprises pieces of operating code to be used collectively to boot the printer.

31. A system comprising:
a plurality of server devices, wherein each server device is configured to store one or more of a plurality of pieces of operating code; and
a network device, coupled to the plurality of server devices, configured to obtain the plurality of pieces of operating code from two or more of the server devices, and further configured to boot the network device using the obtained operating code.

32. A system as recited in claim 31, wherein the network device is further configured to access an operating code identifier comprising a set of instructions that are to be executed to determine a type of the network device and determine the plurality of pieces of the operating code based at least in part on the type.

33. A system as recited in claim 31, wherein the network device is further configured to access an operating code identifier comprising a set of instructions that are to be executed to determine one or more attachments to the network device, and to determine the plurality of pieces of the operating code based at least in part on the one or more attachments.

34. A system comprising:
a base code module configured to allow the system to communicate with one or more server devices via a network and retrieve, from the one or more server devices, a plurality of portions of operating code for the system;
an operating code identifier module configured to identify the plurality of portions of the operating code via an operating code identifier; and
an identifier modification module configured to receive a request to modify the operating code identifier, and to modify the operating code identifier in accordance with the request.

35. A system as recited in claim 34, wherein the operating code identifier comprises a set of conditions and corresponding results that identify one or more of the plurality of portions of the operating code.

36. One or more computer readable media having stored thereon a plurality of instructions that, when executed by one or more controllers of a network device, causes the one or more controllers to:
receive a request to modify an identifier in the network device, wherein the identifier identifies a plurality of portions of operating code used to boot the network device; and
modify the identifier in accordance with the request.

37. One or more computer readable media as recited in claim 36, wherein the instructions that cause the one or more controllers to receive the request comprise instructions that cause the one or more controllers to receive the request from a device via the Internet.

38. One or more computer readable media as recited in claim 36, wherein the instructions that cause the one or more controllers to receive the request comprise instructions that cause the one or more controllers to receive the request from a local input device.

39. One or more computer readable media as recited in claim 36, wherein the instructions further cause the one or more controllers to provide the identifier to the requestor as part of a web page.
